(19) United States
(12) Patent Application Publication
(10) Pub. No.: US 2015/0279208 A1
(43) Pub. Date: Oct. 1, 2015

(54) METHOD AND REMOTE CONTROLLER FOR TRANSMITTING INFRARED SIGNAL

(71) Applicant: Xiaomi Inc., Beijing (CN)

(72) Inventor: Qin Li, Beijing (CN)

(21) Appl. No.: 14/493,355

(22) Filed: Sep. 23, 2014

Related U.S. Application Data
(63) Continuation of application No. PCT/CN2014/082928, filed on Jul. 24, 2014.

(30) Foreign Application Priority Data
Mar. 28, 2014 (CN) 201410124175.3

(51) Int. Cl. G08C 23/04; G08C 19/28

(52) U.S. Cl. CPC G08C 23/04; G08C 19/28

(57) ABSTRACT

The present disclosure relates to a method and a remote controller for transmitting an infrared signal. The method includes: generating a binary sequence corresponding to a key of a remote controller in response to a press on the key; encoding and modulating the binary sequence to obtain a pulse string signal; and transmitting the pulse string signal in form of infrared signal at least twice before the press on the key is released. Through the present disclosure, the problem of the technical solution in the background that the remote controller has weak anti-interference capability and low success rate of remote control can be solved. Thus, the possibility of complete reception of the infrared signals is improved, i.e., the anti-interference capability and success rate of remote control of the remote controller are improved.

### CROSS REFERENCE TO RELATED APPLICATION

This application is a Continuation of International Application No. PCT/CN2014/082928 with an international filing date of Jul. 24, 2014, which is based upon and claims the benefit of priority to Chinese Patent Application No. 201410124175.3, filed on Mar. 28, 2014, the entire contents of which are incorporated herein by reference.

### TECHNICAL FIELD

The present disclosure generally relates to wireless transmission technology, and particularly, to a method and a remote controller for transmitting an infrared signal.

### BACKGROUND

In daily work and life, infrared remote control technology is generally used in wireless remote control of home appliances such as televisions, air conditioners, refrigerators, set-top boxes, etc. The basic principle of the infrared remote control technology is as follows: an infrared signal is sent by a remote controller operated by a user, and a remotely controlled device (a television, an air conditioner, etc.) receives the infrared signal through a built-in receiving circuit and decodes the infrared signal to obtain a control instruction. The control instruction is used to control a corresponding component in the remote controlled device to perform a corresponding operation.

NEC protocol is a commonly used infrared transmission protocol, which defines an infrared signal transmission format. Referring to FIG. 1, which is a block diagram illustratively showing an infrared signal according to the NEC protocol. According to the NEC protocol, a complete infrared signal 10 includes a start code 12, a user code 14 and a data code 16. Since the start code 12 indicates that the remote controller starts to work, the remotely controlled device may be guided to start a decoding program by the start code 12. The start code 12 is typically an AGC (Automatic Gain Control) pulse (a high level) with a pulse width of 9 ms and an idle signal (a low level) with a pulse width of 4.5 ms. The user code 14 is used to identify the type of the remote controller, wherein different types of remote controllers correspond to different user codes 14, respectively. The data code 16 is used to identify a key value of a key, wherein different keys in the remote controller correspond to different key values, respectively. The key values are indicated by the data code 16. In the NEC protocol, both the user code and the data code are of an 8-bit binary sequence. Logic 0 is indicated by a high level pulse signal with a pulse width of 560 us and a low level pulse signal with a pulse width of 560 us; logic 1 is indicated by a high level pulse signal with a pulse width of 560 us and a low level pulse signal with a pulse width of 1680 us. In addition, in the NEC protocol, a signal transmission cycle is 110 ms. In general, over a time period from when a certain key in the remote controller is pressed by a user to when the press on the key is released, the remote controller may transmit a complete infrared signal.

However, in the NEC protocol, the signal transmission cycle is 110 ms, over the time period for when a certain key in the remote controller is pressed by a user to when it is released, the remote controller, usually, can only transmit one complete infrared signal. Since the infrared signal is very sensitive to optical or electromagnetic interferences in the surroundings, the remotely controlled device may be unable to read the complete infrared signal, and thereby unable to decode the infrared signal to obtain the control instruction and to perform the corresponding operation.

### SUMMARY

Accordingly, embodiments of the present disclosure provide a method and an apparatus for transmitting an infrared signal, and a remote controller. The technical solutions are as follows.

According to a first aspect of the embodiments of the present disclosure, a method for transmitting an infrared signal is provided. The method includes: generating a binary sequence corresponding to a key of a remote controller in response to a press on the key; encoding and modulating the binary sequence to obtain a pulse string signal; and transmitting the pulse string signal in form of infrared signal at least twice before the press on the key is released.

According to a second aspect of the embodiments of the present disclosure, a remote controller is provided. The remote controller includes: a processor; a memory configured to store executable instructions by the processor; and an infrared signal transmission unit for transmitting signals; wherein the processor is configured to perform: generating a binary sequence corresponding to a key of the remote controller in response to a press on the key; encoding and modulating the binary sequence to obtain a pulse string signal; and controlling the infrared signal transmission unit to transmit the pulse string signal in form of infrared signal at least twice before the press on the key is released.

According to a third aspect of the embodiments of the present disclosure, a non-volatile storage medium is provided. The non-volatile storage medium has stored therein instructions that, when executed by a processor of a remote controller, causes the remote controller to perform: generating a binary sequence corresponding to a key of a remote controller in response to a press on the key; encoding and modulating the binary sequence to obtain a pulse string signal; and transmitting the pulse string signal in form of infrared signal at least twice before the press on the key is released.

According to a fourth aspect of the embodiments of the present disclosure, an apparatus for transmitting an infrared signal is provided. The apparatus for transmitting an infrared signal comprises: a sequence generating module configured for generating a binary sequence corresponding to a key of a remote controller in response to a press on the key; an encoding and modulating module configured for encoding and modulating the binary sequence to obtain a pulse string signal; and a signal transmission module configured for transmitting the pulse string signal in form of infrared signal at least twice before the press on the key is released.

The technical solutions provided by the embodiments of the present disclosure may have, in part, the following advantageous effects:

During a time period from when certain key in the remote controller is pressed to when the press on the key is released, a binary sequence corresponding to the key is generated. The binary sequence is encoded and modulated to a pulse string signal, and then the pulse string signal is transmitted in form of infrared signal at least twice. Thus, the problem of the technical solution in the background that the remote controller has a weak anti-interference capability and a low success rate of remote control can be solved. In the technical solution provided by the embodiments of the present disclosure, during the time from when certain key in the remote controller is pressed by a user to when the press is released, at least two identical and complete pulse string signals are sequentially and rapidly transmitted in form of infrared signal by the remote controller, as compared with the technical solution in the background in which, during the time from when certain key in the remote controller is pressed to when the press is released, the remote controller may only send one complete infrared signal. Thus, the possibility of complete reception of the infrared signals can be improved, i.e., the anti-interference capability and success rate of remote control of the remote controller can be improved.

It shall be appreciated that the above general description and the following detailed description are only illustrative but not for limiting the present disclosure.

### BRIEF DESCRIPTION OF THE DRAWINGS

In order to clearly explain the embodiments of the present disclosure, hereinafter, the introduction to the drawings required to be used in the depiction of the embodiments will be given simply. It is apparent that the following drawings only illustrate some of the embodiments of the present disclosure, and one of ordinary skill in this art could obtain other drawings based on these drawings without any inventive work.

FIG. 1 is a block diagram illustratively showing an infrared signal according to the NEC protocol;

FIG. 2 is a flow chart showing a method for transmitting an infrared signal according to an exemplary embodiment of the present disclosure;

FIG. 3A is a flow chart showing a method for transmitting an infrared signal according to another exemplary embodiment of the present disclosure;

FIG. 3B is a block diagram illustratively showing different combinations of a high level pulse signal and a low level pulse signal;

FIG. 3C is a block diagram illustratively showing an infrared signal;

FIG. 3D is a block diagram illustratively showing a carrier;

FIG. 4 is a block diagram showing an apparatus for transmitting an infrared signal according to an exemplary embodiment of the present disclosure;

FIG. 5 is a block diagram showing an apparatus for transmitting an infrared signal according to another exemplary embodiment of the present disclosure; and

FIG. 6 is a block diagram showing a remote controller according to an exemplary embodiment of the present disclosure.

Specific embodiments in this disclosure have been shown by way of example in the foregoing drawings and are hereinafter described in detail. The figures and written description are not intended to limit the scope of the inventive concepts in any manner. Rather, they are provided to illustrate the inventive concepts to one of ordinary skill in this art with reference to particular embodiments.

### DETAILED DESCRIPTION

In order to make objects, technical solutions and advantages of the present disclosure more clear, the present disclosure will be described in detail with reference to the accompany drawings. It is apparent that the described embodiments are only a part of but not all of the embodiments of the present disclosure. Based on the embodiments of the present disclosure, other embodiments obtained without paying any creative labor by one of ordinary skill in this art all belong to the protective scope of the present disclosure.

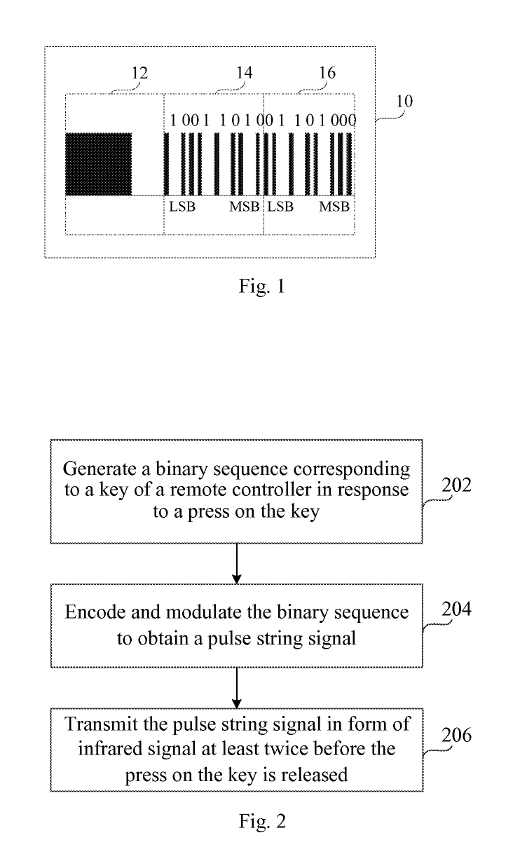

FIG. 2 is a flow chart showing a method for transmitting an infrared signal according to an exemplary embodiment of the present disclosure. The method will be illustrated by way of an example where the method for transmitting the infrared signal is applied in a remote controller. The method for transmitting the infrared signal may include the following steps.

In step 202, a binary sequence corresponding to a key of a remote controller in response to a press on the key is generated.

In step 204, the binary sequence is encoded and modulated to obtain a pulse string signal.

In step 206, the pulse string signal is transmitted in form of infrared signal at least twice before the press on the key is released.

To sum up, in the method for transmitting the infrared signal provided in this embodiment, during a period from when certain key in the remote controller is pressed to when the press on the key is released, a binary sequence corresponding to the key is generated. The binary sequence is encoded and modulated to a pulse string signal, and then the pulse string signal is transmitted in form of infrared signal at least twice. Thus, the problem of the technical solution in the background that the remote controller has a weak anti-interference capability and a low success rate of remote control can be solved. In the technical solution provided by the embodiment, during the period from when certain key in the remote controller is pressed by a user to when the press is released, at least two identical and complete pulse string signals are sequentially and rapidly transmitted in form of infrared signal by the remote controller, as compared with the technical solution in the background in which, during the period from when certain key in the remote controller is pressed to when the press is released, the remote controller may only send one complete infrared signal. Thus, the possibility of complete reception of the infrared signals can be improved, i.e., the anti-interference capability and success rate of remote control of the remote controller can be improved.

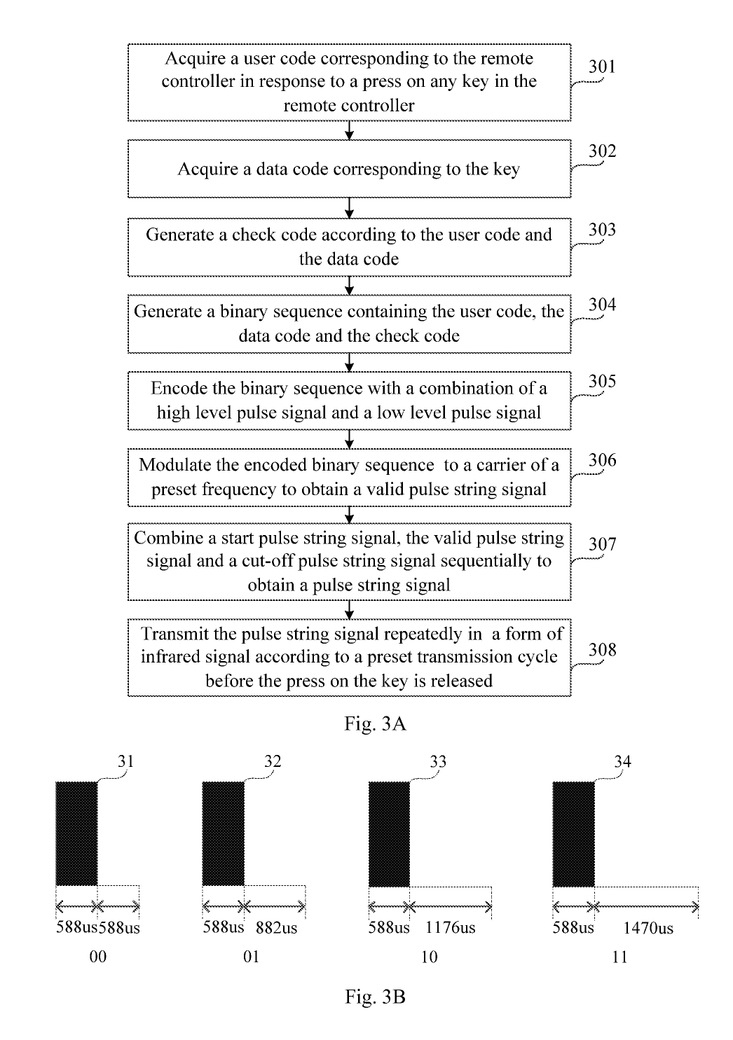

FIG. 3A is a flow chart showing a method for transmitting an infrared signal according to another exemplary embodiment of the present disclosure. This embodiment will be illustrated by way of an example where the method for transmitting the infrared signal is applied in a remote controller. The method for transmitting the infrared signal may include the following steps.

In step 301, a user code corresponding to the remote controller is acquired in response to a press on any key in the remote controller.

For each key in the remote controller, a user code corresponding to the remote controller is acquired when the key is pressed. The user code is used to identify the type of the remote controller, and different types of remote controllers correspond to different user codes, respectively. For example, a type A remote controller corresponds to a user code “0x86” (a hexadecimal number), and a type B remote controller corresponds to a user code “0x88”. In an infrared transmission protocol provided in this embodiment, the user code is indicated by an 8-bit binary sequence (C7 C6 C5 C4 C3 C2 C1 C0). For example, 0x86 is transformed to an 8-bit binary sequence “10000110”.

It would be appreciated that the user code may also be indicated by a 16-bit binary sequence in other implementations, and the present embodiment does not impose specific limitations on this.

After receiving the infrared signal transmitted by the remote controller, the remotely controlled device may recognize, according to the user code, whether the infrared signal is an infrared signal sent by a remote controller associated with the remotely controlled device. If the remote controlled device recognizes that the infrared signal is the infrared signal sent by the remote controller associated with the remotely controlled device, the remotely controlled device may perform decoding operation to obtain a control instruction, and corresponding components are controlled to perform corresponding operations according to the control instruction.

In step 302, a data code corresponding to the key is acquired.

The remote controller acquires a data code corresponding to the key. The data code is configured to identify a key value of a key. Different keys in the remote controller correspond to different key values, respectively, and the key values are indicated by data codes. For example, a key value of a home key is 0x08, and a key value of a search key is 0xd2, and a key value of a play/pause key is 0x89, and so on. Similar to the user code, the data code is indicated by an 8-bit binary sequence (D7 D6 D5 D4 D3 D2 D1 D0). For example, 0x08 is transformed to an 8-bit binary sequence “00001000”.

It would be appreciated that, the data code may also be indicated by a 16-bit binary sequence in other implementations, and the present embodiment does not impose specific limitations on this.

It should be noted that, the above step 302 may be performed before step 301, after step 301, or simultaneously with step 301. This embodiment is illustrated only by way of example where step 302 is performed before step 301, but the present embodiment does not impose limitations on this.

In step 303, a check code is generated according to the user code and the data code.

After acquiring the user code and the data code, the remote controller generates a check code according to the user code and the data code. The check code is used to check whether the user code and the data code obtained by decoding of the remote controlled device are correct.

The remote controller may generate the check code by one of the following two implementations:

In a first implementation, calculations are performed on the user code and the data code according to a preset algorithm to obtain the check code.

The preset algorithm may be any one of algorithms such as addition, subtraction, multiplication and exclusive OR (XOR) operation, and so on. Assuming that the preset algorithm is the XOR operation, then the check code (P7 P6 P5 P4 P3 P2 P1 P0)=(C7 C6 C5 C4 C3 C2 C1 C0) XOR (D7 D6 D5 D4 D3 D2 D1 D0). For example, when the user code is 10000110 and the data code is 00001000, the check code obtained by performing XOR operation on the user code and the data code is as follows: (P7 P6 P5 P4 P3 P2 P1 P0)=(10000110) XOR (00001000)=10001110.

In a second implementation, the check code is obtained by averagely dividing the user code and the data code into m segments, m≧2 and sequentially calculating the check code from the m segments of the user code and the m segments of the data code arranged in order according to the preset algorithm.

In order to shorten a length of the check code and a length of the pulse string signal obtained, the remote controller may averagely divide the user code and the data code into m segments. In this embodiment, assuming that m=2, then the user code may be divided into two segments, including (C7 C6 C5 C4) and (C3 C2 C1 C0). The data code may be divided into two segments including (D7 D6 D5 D4) and (D3 D2 D1 D0). Afterwards, the remote controller sequentially performs calculations on the m segments of the user code and the m segments of the data code arranged in order according to the preset algorithm to obtain the check code. The preset algorithm may be any one of algorithms such as addition, subtraction, multiplication and XOR operation, and so on.

Assuming that the preset algorithm is the XOR operation, then the check code (P3 P2 P1 P0) =(C7 C6 C5 C4) XOR (C3 C2 C1 C0) XOR (D7 D6 D5 D4) XOR (D3 D2 D1 D0). For example, when the user code is 10000110 and the data code is 00001000, the check code obtained by sequentially performing calculations on the two segments of the user code and the two segments of the data code arranged in order using the XOR operation is (P3 P2 P1 P0)=(1000) XOR (0110) XOR (0000) XOR (1000)=0110.

In step 304, a binary sequence containing the user code, the data code and the check code is generated.

The remote controller generates the binary sequence containing the user code, the data code and the check code. In this embodiment, assuming that the binary sequence includes an 8-bit user code (C7 C6 C5 C4 C3 C2 C1 C0), an 8-bit data code (D7 D6 D5 D4 D3 D2 D1 D0) and a 4-bit check code (P3 P2 P1 P0) which are arranged in order.

In step 305, the binary sequence is encoded with a combination of at least a high level pulse and a low level pulse.

The remote controller encodes the binary sequence with the combination of at least a high level pulse and a low level pulse.

In this embodiment, this step may include the following sub steps.

Firstly, the binary sequence is averagely divided into n binary sequence segments, wherein each binary sequence segment contains a binary number of at least two bits (n≧1).

In order to make the length of the obtained pulse string signal relatively short, segment encoding is performed on the binary sequence, instead of directly performing encoding on the binary sequence bit by bit. Assuming that each binary sequence segment contains a two-bit binary number, then in this embodiment, the remote controller averagely divides the binary sequences (C7 C6 C5 C4 C3 C2 C1 C0), (D7 D6 D5 D4 D3 D2 D1 D0) and (P3 P2 P1 P0) into 10 binary sequence segments. In each binary sequence segment, a possible combination of logic 0 and logic 1 is one of 00, 01, 10 and 11.

Secondly, the combinations of high level and low level pulses corresponding to respective binary sequence segments are acquired according to a preset correlation between the binary sequence segments and the combinations of high level and low level pulse signals.

The preset correlation between the binary sequence segments and the combinations of high level and low level pulses is stored in the remote controller in advance. The remote controller acquires the combinations of high level and low level pulses corresponding to respective binary sequence segments according to the preset correlation.

When each binary sequence segment contains a two-bit binary number, the above preset correlation may include: the binary sequence segment of “00” corresponding to a high level pulse with a first pulse width and a low level pulse with a second pulse width; the binary sequence segment of “01” corresponding to a high level pulse with the first pulse width and a low level pulse with a third pulse width; the binary sequence segment of “10” corresponding to a high level pulse with the first pulse width and a low level pulse with a fourth pulse width; and the binary sequence segment of “11” corresponding to a high level pulse with the first pulse width and a low level pulse with a fifth pulse width. The second pulse width, the third pulse width, the fourth pulse width and the fifth pulse width are different from each other.

Referring to FIG. 3B, which illustratively shows a correlation between different binary sequence segments and different combinations of high level and low level pulses when each binary sequence segment contains a two-bit binary number. The binary sequence segment of “00” 31 is indicated by a high level pulse with a 588 us pulse width and a low level pulse with a 588 us pulse width; the binary sequence segment of “01” 32 is indicated by a high level pulse with a 588 us pulse width and a low level pulse with a 882 us pulse width; the binary sequence segment of “10” 33 is indicated by a high level pulse with a 588 us pulse width and a low level pulse with a 1176 us pulse width; and the binary sequence segment of “11” 34 is indicated by a high level pulse with a 588 us pulse width and a low level pulse with a 1470 us pulse width.

It should be noted that, the above high level and low level are not the common concept “voltage level” in the field of electronic circuits. They are only indications for representing binary sequence segments “00”, “01”, “10” and “11”. In other words, in the subsequent infrared signal emission process, the infrared signal is not emitted during the low level period, and the infrared signal is emitted during the high level period.

Thirdly, the acquired n combinations of high level and low level pulses are arranged in order so as to obtain an encoded binary sequence.

After the remote controller acquires combinations of high level and low level pulses corresponding to the respective binary sequence segments, according to an order of respective binary sequence segments in the binary sequence, the remote controller correspondingly arranges the combinations of high level and low level pulses in order, so as to obtain an encoded binary sequence.

Referring to FIG. 3C, which is a block diagram illustratively showing an infrared signal 35 according to the method for transmitting the infrared signal provided by this embodiment. The encoded binary sequence contains a user code “10000110”, a data code “00001000”, and a check code “0110”, which are indicated by 10 pairs of high level and low level pulses.

In step 306, the encoded binary sequence is modulated to a carrier of a preset frequency to obtain a valid pulse string signal.

The remote controller modulates the encoded binary sequence to the carrier of the preset frequency to obtain the valid pulse string signal that carries the user code, the data code and the check code.

Referring to FIG. 3D, which is a block diagram illustratively showing the carrier according to the method for transmitting the infrared signal provided by this embodiment. The carrier 39 is a 37.92 kHz pulse signal with a cycle of 26.37 us, a pulse width of 8.79 us and a duty ratio of ⅓.

In step 307, a start pulse string signal, the valid pulse string signal and a stop pulse string signal are combined sequentially to obtain a pulse string signal.

The remote controller combines the start pulse string signal, the valid pulse string signal and the stop pulse string signal sequentially to obtain the pulse string signal. The start pulse string signal is used to indicate that the remote controller starts to work, and the remote controlled device is guided into a decoding program by the start pulse string signal. Referring to FIG. 3C, in this embodiment, the start pulse string signal 36 includes an AGC pulse (high level) with a width of 1008.8 us and an idle signal (low level) with a width of 588 us. The stop pulse string signal is used to indicate that transmission of a complete infrared signal is ended. Referring to FIG. 3C, in this embodiment, the stop pulse string signal 37 is the AGC pulse (high level) with the width of 588 us. The valid pulse string signal 38 is the signal obtained in the above step 306.

The pulse string signal 35 is the signal to be transmitted in form of infrared signal by the remote controller. The pulse string signal 35 includes the start pulse string signal 36, the valid pulse string signal 38 and the stop pulse string signal 37 arranged sequentially. The remote controller transmits the start pulse string signal 36, the valid pulse string signal 38 and the stop pulse string signal 37 in the above sequence in a subsequent transmission process.

In step 308, the pulse string signal is transmitted repeatedly in from of infrared signal according to a preset transmission cycle before the press on the key is released.

Before the press on the key is released, the remote controller transmits the pulse string signal repeatedly in form of infrared signal according to the preset transmission cycle. When the remote controller operates normally, in order to ensure that over a time period from when certain key in the remote controller is pressed by a user to when the key is released, the remote controller completely sends the pulse string signal at least twice in form of infrared signal, the preset transmission cycle may be less than a predetermined threshold.

After periods for pressing a key by some users are sampled in advance, the predetermined threshold may be set according to sample periods of key being pressed by various users, which may be sampled in advance. The key pressing period is a period from when a user presses a key in a remote controller to when he releases the key under a normal operation state. For example, the key pressing periods of 100 users can be sampled for a plurality of times in advance to obtain 1000 samples, wherein the calculated average key pressing period is 100 ms. Then, in some exemplary embodiments, the predetermined threshold is set as 100 ms/2=50 ms. That is, the preset transmission cycle should be less than 50 ms.

The shorter the preset transmission cycle is set, the higher the transmission frequency of the signals will be, and more complete pulse string signals will be sent in form of infrared signal by the remote controller over the time period from press to release of certain key. Thus, the possibility of complete reception of the infrared signals will be improved, i.e., the anti-interference capability and success rate of remote control of the remote controller are improved. Referring to FIG. 3C, in this embodiment, the preset transmission cycle is 30 ms, and the remote controller repeatedly transmits the pulse string signal 35 once every 30 ms over the time period from press to release of certain key.

To sum up, in the method for transmitting an infrared signal provided by this embodiment, during a period from the timing of certain key in the remote controller being pressed to the timing of the press on the key being released, a binary sequence corresponding to the key is generated. The binary sequence is encoded and modulated to a pulse string signal, and then the pulse string signal is transmitted in form of infrared signal at least twice. Thus, the problem of the technical solution in the background that the remote controller has a weak anti-interference capability and a low success rate of remote control can be solved. In the technical solution provided by the embodiment, during the period from the timing of certain key in the remote controller being pressed to the timing of the press on the key being released, at least two identical and complete pulse string signals are sequentially and rapidly transmitted in form of infrared signal by the remote controller, as compared with the technical solution in the background in which, during the period from when certain key in the remote controller is pressed to when the press is released, the remote controller may only send one complete infrared signal. Thus, the possibility of complete reception of the infrared signals can be improved, i.e., the anti-interference capability and success rate of remote control of the remote controller can be improved.

In addition, in the method for transmitting an infrared signal provided by this embodiment, the length of the check code may be shortened and the length of the pulse string signal obtained by subsequent encoding and modulating may be relatively short by way of dividing the user code and the data code into segments and then calculating the check code therefrom. This provides a guarantee for shortening the signal transmission cycle. Moreover, by performing segment encoding on the binary sequence, the length of the pulse string signal obtained by encoding and modulating may be further shortened, and this provides a more sufficient guarantee for shortening the signal transmission cycle.

The following are apparatus embodiments of the present disclosure which may be used to perform the method embodiments of the present disclosure. The details not disclosed in the apparatus embodiments of the present disclosure may be referred to the method embodiments of the present disclosure.

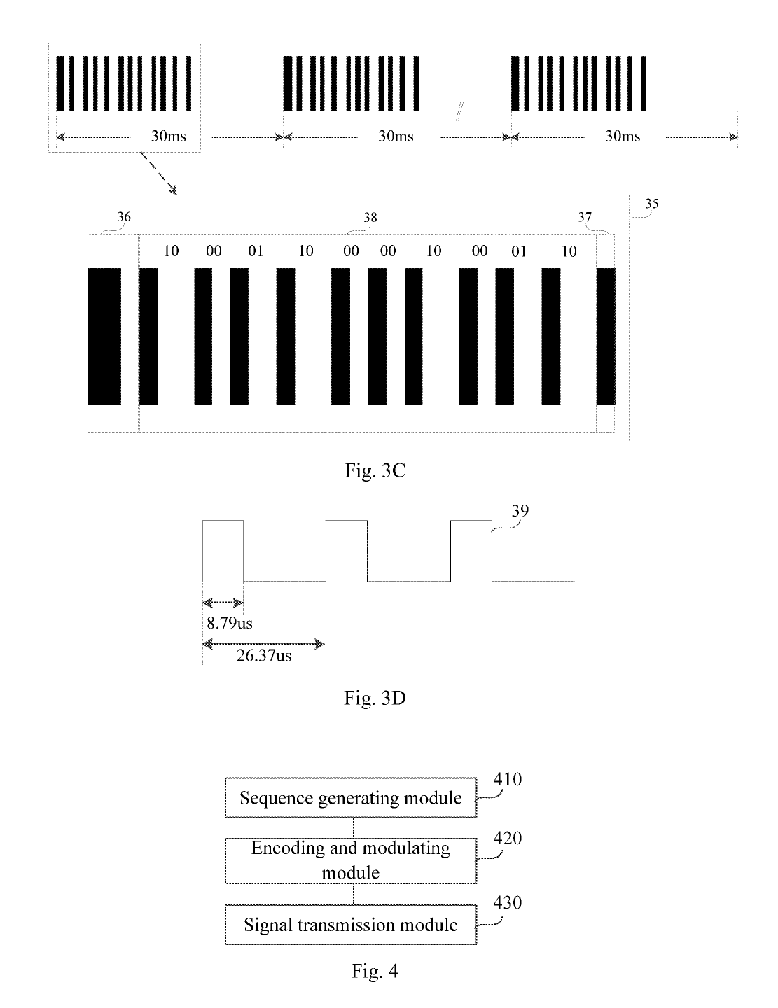

FIG. 4 is a block diagram showing an apparatus for transmitting an infrared signal according to an exemplary embodiment of the present disclosure. The apparatus for transmitting the infrared signal may be implemented by software, hardware or a combination thereof into a part of or whole of a remote controller. The apparatus for transmitting an infrared signal may include a sequence generating module 410, an encoding and modulating module 420 and a signal transmission module 430.

The sequence generating module 410 is configured to generate a binary sequence corresponding to a key of a remote controller in response to a press on the key.

The encoding and modulating module 420 is configured to encode and modulate the binary sequence to obtain a pulse string signal.

The signal transmission module 430 is configured to transmit the pulse string signal in form of infrared signal at least twice before the press on the key is released

To sum up, in the apparatus for transmitting the infrared signal provided by this embodiment, during a period from when certain key in the remote controller is pressed to when the press on the key is released, a binary sequence corresponding to the key is generated. The binary sequence is encoded and modulated to a pulse string signal, and then the pulse string signal is transmitted in form of infrared signal at least twice. Thus, the problem of the technical solution in the background that the remote controller has a weak anti-interference capability and a low success rate of remote control can be solved. In the technical solution provided by the embodiment, during the period from the timing of certain key in the remote controller being pressed to the timing of the press on the key being released, at least two identical and complete pulse string signals are sequentially and rapidly transmitted in form of infrared signal by the remote controller, as compared with the technical solution in the background in which, during the period from the timing of certain key in the remote controller being pressed to the timing of the press on the key being released, the remote controller may only send one complete infrared signal. Thus, the possibility of complete reception of the infrared signals can be improved, i.e., the anti-interference capability and success rate of remote control of the remote controller can be improved.

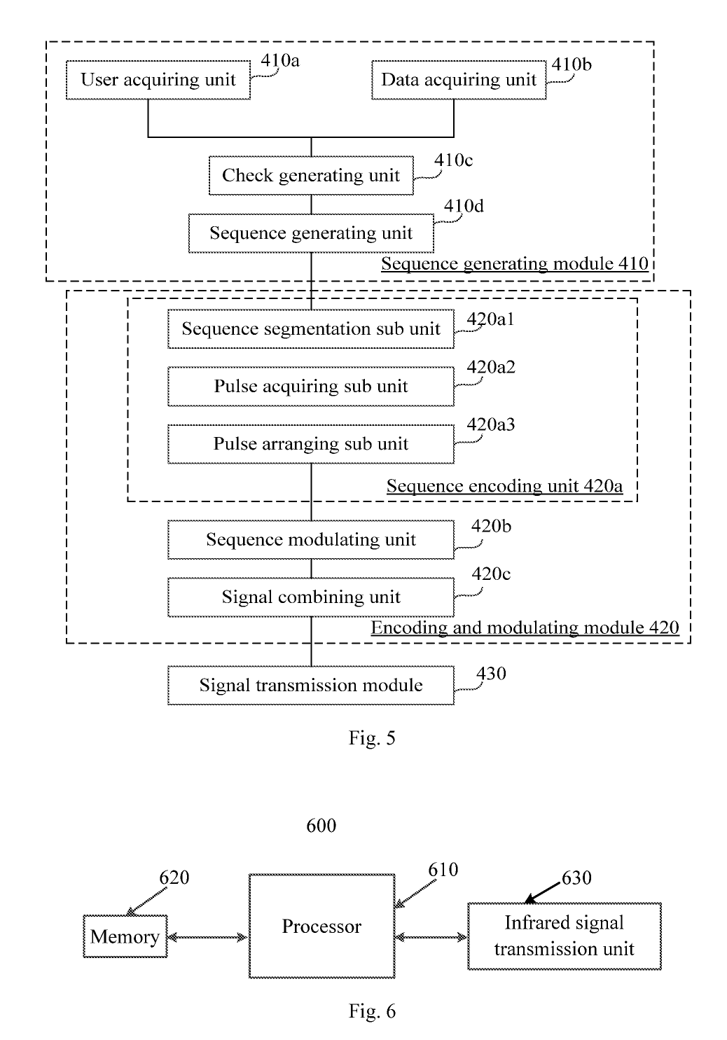

FIG. 5 is a block diagram showing an apparatus for transmitting an infrared signal according to another exemplary embodiment of the present disclosure. The apparatus for transmitting the infrared signal may be implemented by software, hardware or a combination of thereof into a part of or whole of a remote controller. The apparatus for transmitting an infrared signal may include a sequence generating module 410, an encoding and modulating module 420, and a signal transmission module 430.

The sequence generating module 410 is configured to generate a binary sequence corresponding to a key of a remote controller in response to a press on the key.

The sequence generating module 410 includes a user acquiring unit 410a, a data acquiring unit 410b, a check code generating unit 410c and a sequence generating unit 410d.

The user acquiring unit 410a is configured to acquire a user code corresponding to the remote controller when the key is pressed.

The data acquiring unit 410b is configured to acquire a data code corresponding to the key pressed.

The check generating unit 410c is configured to generate a check code according to the user code and the data code.

The check generating unit 410c includes a direct calculation sub-unit or a segmented calculation sub-unit.

The direct calculation sub-unit is configured to calculate the check code from the user code and the data code according to a preset algorithm.

The segment calculation sub unit is configured to divide the user code and the data code averagely into m segments, m≧2; and sequentially calculate the check code from the m segments of the user code and the m segments of the data code arranged in order according to a preset algorithm.

The sequence generating unit 410d is configured to generate a binary sequence containing the user code, the data code and the check code.

The encoding and modulating module 420 is configured to encode and modulate the binary sequence to obtain a pulse string signal.

The encoding and modulating module 420 includes a sequence encoding unit 420a, a sequence modulating unit 420b and a signal combining unit 420c.

The sequence encoding unit 420a is configured to encode the binary sequence with a combination of at least a high level pulse and a low level pulse.

The sequence encoding unit 420a includes a sequence segmentation sub unit 420a1, a pulse acquiring sub unit 420a2 and a pulse arranging sub unit 420a3.

The sequence segmentation sub unit 420a1 is configured to divide the binary sequence into n binary sequence segments averagely, and each binary sequence segment comprises a binary number of at least two bits, n≧1.

The pulse acquiring sub unit 420a2 is configured to acquire one or more combinations of high level and low level pulses corresponding to the n binary sequence segments, respectively, according to a preset correlation between the binary sequence segments and the combinations of high level and low level pulses.

For example, when each binary sequence segment contains a two-bit binary number, the correlation between the binary sequence segments and the combinations of high level and low level pulses includes: the binary sequence segment of “00” corresponding to a high level pulse with a first pulse width and a low level pulse with a second pulse width; the binary sequence segment of “01” corresponding to a high level pulse with the first pulse width and a low level pulse with a third pulse width; the binary sequence segment of “10” corresponding to a high level pulse with the first pulse width and a low level pulse with a fourth pulse width; and the binary sequence segment of “11” corresponding to a high level pulse with the first pulse width and a low level pulse with a fifth pulse width. The second pulse width, the third pulse width, the fourth pulse width and the fifth pulse width are different from each other.

The pulse arranging sub unit 420a3 is configured to arrange the acquired n combinations of high level and low level pulses sequentially, so as to obtain the encoded binary sequence.

The sequence modulating unit 420b is configured to modulate the encoded binary sequence to a carrier of a preset frequency to obtain a valid pulse string signal.

The signal combining unit 420c is configured to combine a start pulse string signal, the valid pulse string signal and a stop pulse string signal sequentially, so as to obtain the pulse string signal.

The signal transmission module 430 is configured to transmit the pulse string signal in form of infrared signal at least twice before the press on the key is released.

The signal transmission module 430 is further configured to transmit the pulse string signal repeatedly in form of infrared signal according to a preset transmission cycle before the press on the key is released.

To sum up, in the apparatus for transmitting an infrared signal provided by this embodiment, during a period from the timing of certain key in the remote controller being pressed to the timing of the press on the key being released, a binary sequence corresponding to the key is generated. The binary sequence is encoded and modulated to a pulse string signal, and then the pulse string signal is transmitted in form of infrared signal at least twice. Thus, the problem of the technical solution in the background that the remote controller has a weak anti-interference capability and a low success rate of remote control can be solved. In the technical solution provided by the embodiment, during the period from when certain key in the remote controller is pressed by a user to when the press is released, at least two identical and complete pulse string signals are sequentially and rapidly transmitted in form of infrared signal by the remote controller, as compared with the technical solution in the background in which, during the period from the timing of certain key in the remote controller being pressed to the timing of the press on the key being released, the remote controller may only send one complete infrared signal. Thus, the possibility of complete reception of the infrared signals can be improved, i.e., the anti-interference capability and success rate of remote control of the remote controller can be improved.

In addition, in the apparatus for transmitting an infrared signal provided by this embodiment, the length of the check code may be shortened and the length of the pulse string signal obtained by subsequent encoding and modulating may be relatively short by way of dividing the user code and the data code into segments and then calculating the check code therefrom. This provides a guarantee for shortening the signal transmission cycle. Moreover, by performing segment encoding on the binary sequence, the length of the pulse string signal obtained by encoding and modulating may be further shortened, and this provides a more sufficient guarantee for shortening the signal transmission cycle.

With respect to the apparatus in the above embodiments, specific operations performed by each module has been described in detail in the method embodiments, which will not elaborated herein.

FIG. 6 is a block diagram showing a remote controller according to an exemplary embodiment of the present disclosure. The remote controller 600 includes a processor 610, a memory 620 configured to store executable instructions by the processor 610, and an infrared signal transmission unit 630.

One or more programs are stored in the memory 620 and configured to be executed by the processor 610. The one or more programs contain instructions for performing the following steps: generating a binary sequence corresponding to a key of a remote controller in response to a press on the key; encoding and modulating the binary sequence to obtain a pulse string signal; and transmitting the pulse string signal in form of infrared signal at least twice before the press on the key is released.

Alternatively, the one or more programs further contains instructions for perform the following steps: acquiring a user code corresponding to the remote controller when the key is pressed; acquiring a data code corresponding to the key pressed; generating a check code according to the user code and the data code; and generating the binary sequence containing the user code, the data code and the check code.

Alternatively, the one or more programs further contains instructions for performing the following steps: calculating the check code from the user code and the data code according to a preset algorithm; or dividing the user code and the data code averagely into m segments, m≧2; and sequentially calculating the check code from the m segments of the user code and the m segments of the data code arranged in order according to the preset algorithm.

Alternatively, the one or more programs further contains instructions for performing the following steps: encoding the binary sequence with a combination of at least a high level pulse and a low level pulse; modulating the encoded binary sequence to a carrier of a preset frequency to obtain a valid pulse string signal; and combining a start pulse string signal, the valid pulse string signal and a stoop pulse string signal sequentially to obtain the pulse string signal.

Alternatively, the one or more programs further contains instructions for performing the following steps: averagely dividing the binary sequence into n binary sequence segments, and each binary sequence segment contains a binary number of at least two bits, n≧1; acquiring one or more combinations of high level and low level pulses corresponding to the n binary sequence segments, respectively, according to a preset correlation between the binary sequence segments and the combinations of high level and low level pulses; and arranging the acquired n combinations of high level and low level pulses sequentially, so as to obtain the encoded binary sequence

Alternatively, the one or more programs further contains instructions for performing the following step: transmitting the pulse string signal repeatedly in form of infrared signal according to a preset transmission cycle before the press on the key is released.

An exemplary embodiment of the present disclosure also provides a non-volatile storage medium having stored therein instructions that, when executed by the processor 610 of the remote controller 600, causes the remote controller 600 to perform: for each key in a remote controller, generating a binary sequence corresponding to a key of a remote controller in response to a press on the key; encoding and modulating the binary sequence to obtain a pulse string signal; and transmitting the pulse string signal in form of infrared signal at least twice before the press on the key is released.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for transmitting an infrared signal, comprising:
generating a binary sequence corresponding to a key of a remote controller in response to a press on the key;
encoding and modulating the binary sequence to obtain a pulse string signal; and
transmitting the pulse string signal in form of infrared signal at least twice before the press on the key is released.

2. The method according to claim 1, wherein generating the binary sequence corresponding to the key of the remote controller in response to the press on the key comprises:
acquiring a user code corresponding to the remote controller;
acquiring a data code corresponding to the key pressed;
generating a check code according to the user code and the data code; and
generating the binary sequence containing the user code, the data code and the check code.

3. The method according to claim 2, wherein generating the check code according to the user code and the data code comprises:
calculating the check code from the user code and the data code according to a preset algorithm; or dividing the user code and the data code averagely into m segments, m≧2; and
sequentially calculating the check code from the m segments of the user code and the m segments of the data code arranged in order according to the preset algorithm.

4. The method according to claim 1, wherein encoding and modulating the binary sequence to obtain the pulse string signal comprises:
encoding the binary sequence with a combination of at least a high level pulse signal and a low level pulse signal;
modulating the encoded binary sequence into a carrier of a preset frequency to obtain a valid pulse string signal; and
combining a start pulse string signal, the valid pulse string signal and a stop pulse string signal sequentially, so as to obtain the pulse string signal.

5. The method according to claim 4, wherein encoding the binary sequence with a combination of high level and low level pulses comprises:
dividing the binary sequence into n binary sequence segments averagely, each binary sequence segment comprising a binary number of at least two bits, n≧1;
acquiring one or more combinations of high level and low level pulses corresponding to the n binary sequence segments, respectively, according to a preset correlation between the binary sequence segments and the combinations of high level and low level pulses; and
arranging the acquired n combinations of high level and low level pulses sequentially, so as to obtain the encoded binary sequence.

6. The method according to claim 5, wherein when each binary sequence segment comprises a two-bit binary number, the preset correlation between the binary sequence segment and the combination of high level and low level pulses comprises:
the binary sequence segment of “00” corresponding to a high level pulse signal with a first pulse width and a low level pulse signal with a second pulse width;
the binary sequence segment of “01” corresponding to a high level pulse signal with the first pulse width and a low level pulse signal with a third pulse width;
the binary sequence segment of “10” corresponding to a high level pulse signal with the first pulse width and a low level pulse signal with a fourth pulse width; and
the binary sequence segment of “11” corresponding to a high level pulse signal with the first pulse width and a low level pulse signal with a fifth pulse width;
wherein the second pulse width, the third pulse width, the fourth pulse width and the fifth pulse width are different from each other.

7. The method according to claim 1, wherein transmitting the pulse string signals in form of infrared signal before the press on the key is released comprises:
transmitting the pulse string signal repeatedly in form of infrared signal according to a preset transmission cycle before the press on the key is released.

8. The method according to claim 2, wherein transmitting the pulse string signals in form of infrared signal before the press on the key is released comprises:
transmitting the pulse string signal repeatedly in form of infrared form according to a preset transmission cycle before the press on the key is released.

9. The method according to claim 3, wherein transmitting the pulse string signals in form of infrared signal before the press on the key is released comprises:
transmitting the pulse string signal repeatedly in form of infrared form according to a preset transmission cycle before the press on the key is released.

10. A remote controller, comprising:
a processor;
a memory configured to store executable instructions by the processor; and
an infrared signal transmission unit for transmitting signals;
wherein the processor is configured to perform:
generating a binary sequence corresponding to a key of the remote controller in response to a press on the key;
encoding and modulating the binary sequence to obtain a pulse string signal; and
controlling the infrared signal transmission unit to transmit the pulse string signal in form of infrared signal at least twice before the press on the key is released.

11. The remote controller according to claim 10, wherein generating the binary sequence corresponding to the key of the remote controller in response to the press on the key comprises:
acquiring a user code corresponding to the remote controller when the key is pressed;
acquiring a data code corresponding to the key pressed;
generating a check code according to the user code and the data code; and
generating the binary sequence containing the user code, the data code and the check code.

12. The remote controller according to claim 11, wherein generating the check code according to the user code and the data code comprises:
calculating the check code from the user code and the data code according to a preset algorithm; or dividing the user code and the data code averagely into m segments, m≧2; and
sequentially calculating the check code from the m segments of the user code and the m segments of the data code arranged in order according to the preset algorithm.

13. The remote controller according to claim 10, wherein encoding and modulating the binary sequence to obtain the pulse string signal comprises:
encoding the binary sequence with a combination of at least a high level pulse signal and a low level pulse signal;
modulating the encoded binary sequence into a carrier of a preset frequency to obtain a valid pulse string signal; and
combining a start pulse string signal, the valid pulse string signal and a stop pulse string signal sequentially, so as to obtain the pulse string signal.

14. The remote controller according to claim 13, wherein encoding the binary sequence with a combination of high level and low level pulses comprises:
dividing the binary sequence into n binary sequence segments averagely, each binary sequence segment comprising a binary number of at least two bits, n≧1;
acquiring one or more combinations of high level and low level pulses corresponding to the n binary sequence segments, respectively, according to a preset correlation between the binary sequence segments and the combinations of high level and low level pulses; and
arranging the acquired n combinations of high level and low level pulses sequentially, so as to obtain the encoded binary sequence.

15. The remote controller according to claim 14, wherein when each binary sequence segment comprises a two-bit binary number, the preset correlation between the binary sequence segment and the combination of high level and low level pulses comprises:
the binary sequence segment of “00” corresponding to a high level pulse signal with a first pulse width and a low level pulse signal with a second pulse width;
the binary sequence segment of “01” corresponding to a high level pulse signal with the first pulse width and a low level pulse signal with a third pulse width;
the binary sequence segment of “10” corresponding to a high level pulse signal with the first pulse width and a low level pulse signal with a fourth pulse width; and
the binary sequence segment of “11” corresponding to a high level pulse signal with the first pulse width and a low level pulse signal with a fifth pulse width;
wherein the second pulse width, the third pulse width, the fourth pulse width and the fifth pulse width are different from each other.

16. The remote controller according to claim 10, wherein transmitting the pulse string signals in form of infrared signal before the press on the key is released comprises:
transmit the pulse string signal repeatedly in form of infrared form according to a preset transmission cycle before the press on the key is released

17. The remote controller according to claim 11, wherein transmitting the pulse string signals in form of infrared signal before the press on the key is released comprises:
transmit the pulse string signal repeatedly in form of infrared form according to a preset transmission cycle before the press on the key is released.

18. The remote controller according to claim 12, wherein transmitting the pulse string signals in form of infrared signal before the press on the key is released comprises:
transmit the pulse string signal repeatedly in form of infrared form according to a preset transmission cycle before the press on the key is released.

19. The remote controller according to claim 13, wherein transmitting the pulse string signals in form of infrared signal before the press on the key is released comprises:
transmit the pulse string signal repeatedly in form of infrared form according to a preset transmission cycle before the press on the key is released.

20. A non-volatile storage medium having stored therein instructions that, when executed by a processor of a remote controller, causes the remote controller to perform:
generating a binary sequence corresponding to a key of a remote controller in response to a press on the key;
encoding and modulating the binary sequence to obtain a pulse string signal; and
transmitting the pulse string signal in form of infrared signal at least twice before the press on the key is released.
